(19) United States
(12) Patent Application Publication
(10) Pub. No.: US 2010/0179242 A1
(43) Pub. Date: Jul. 15, 2010

(54) PHOTO-ACTIVATION BY SURFACE PLASMON RESONANCE

(76) Inventors: Sergey Anatoliyovich Piletsky, Bedfordshire (GB); Michael James Whitcombe, Norfolk (GB); Volodymyr Chegel, Kiev (UA)

Correspondence Address: STITES & HARBISON PLLC, 1199 NORTH FAIRFAX STREET, SUITE 900, ALEXANDRIA, VA, 22314, US

(21) Appl. No.: 12/375,243

(22) PCT Filed: Jul. 28, 2007
(86) PCT No.: PCT/GB2007/002883

§ 371 Date: Nov. 25, 2009

(30) Foreign Application Priority Data
Jul. 28, 2006 (GB) 0614992.6

(51) Int. Cl. C08F 2/48

(52) U.S. Cl. 522/175; 522/182; 522/188

(57) ABSTRACT

In general, the present invention describes the initiation of photochemical reactions at a metal-solution interface irradiated by light. Surface plasmon energy is used to initiate reaction of species in solution, the reaction occurring at, on or near a surface which is in contact with the solution. The present invention describes an application of this effect e.g. for polymerization purposes.

Broadly the present application relates to methods for the photo-initiation of chemical reactions at, on or very near to a metal surface, using SPR phenomena.

The present application further describes the creation of thin polymeric films at a metal-solution interface irradiated by light. Specifically polymerization is powered by electromagnetic field of light-generated surface plasmon in metals. The energy of evanescent field is used to activate formation of radicals which leads to polymerization or cross-linking. Due to the nature of evanescent field the polymerization takes place in close proximity to the metal layer. The resulting structures find use in a variety of applications, including sensors and assays, separation, holography and microelectronics.

### BACKGROUND OF THE INVENTION

1. Field of the Invention

The present invention relates to the application of surface plasmon resonance (SPR) phenomena, and to the fields of polymeric materials, polymerization processes and application of such.

References.

| Patent | Country | Issued | Title |
|---|---|---|---|
| U.S. Pat. No. 7,049,049 | USA | May 23, 2006 | Maskless photolithography for using |
| | | | photoreactive agents |
| EP1331516 | USA | Jul. 30, 2003 | Method and mask for fabricating features |
| | | | in a polymer layer |
| US20030129545 | USA | Jul. 10, 2003 | Method and apparatus for use of Plasmon |
| | | | printing in near-field lithography |
| US20050233262 | JP | Oct. 20, 2005 | Lithography mask and optical lithography |
| | | | method using surface Plasmon |
| U.S. Pat. No. 6,379,976 | SE | Apr. 30, 2002 | Determination of |
| | | | polymerization/coagulation in a fluid |
| WO 01/55235 | GB | Aug. 02, 2001 | Molecularly imprinted polymer |
| U.S. Pat. No. 6,852,818 | GB | Feb. 08, 2005 | Molecularly imprinted polymers produced |
| | | | by template polymerization |
| WO 2006/129088 | GB | Jul. 12, 2006 | Preparation of soluble and colloidal |
| | | | molecularly imprinted polymers by living |
| | | | polymerization |

[1] Born, M.; Wolf, E. Principles of Optics.—Pergamon Press, 1980.
[2] Sainov, S.; Stoycheva-Topalova, R. Total internal reflection holographic recording in very thin films. J. Opt. A: Pure Appl. Opt. 2000, 2, 117-120.
[3] Kik, P. G.; Maier, S. A.; Atwater, H. A. Plasmon printing—a new approach to near-field lithography. Mat. Res. Soc. Symp. Proc. 2002, 705, Y3.6.
[4] Kik, P. G.; Martin, A. L.; Maier, S. A.; Atwater, H. A. Metal nanoparticle arrays for near field optical lithography. SPIE Proc. 2002, 4810, 7-13.
[5] Kik, P. G.; Maier, S. A.; Atwater, H. A. Surface plasmons for nanofabrication. SPIE Proc. 2004, 5347, 215-223.
[6] Sundaramurthy, A.; Schuck, P. J.; Conley, N. R. et al. Towards nanometre-scale optical photolithography: Utilizing the near-field of bowtie optical nanoantennae. Nano Lett. 2006, 6, 355-360.
[7] Kroger, E.; Kretschmann, E. Z. Phys. 1970, 237, 1.
[8] Heitman, D.; Raether, H. Light emission of non-radiative surface plasmons from sinusoidally modulated silver surfaces. Surface Sci. 1976, 59, 7-22.
[9] Beev, K.; Criante, L.; Lucchetta, D. E. et al. Recording of evanescent waves in holographic polymer dispersed liquid crystals. J. Opt. A: Pure Appl. Opt. 2006, 8, 205-207.
[10] Agranovich, V. M.; Mills, D. L. (eds.), Surface Polaritons, North-Holland, Amsterdam, 1982.
[11] Zhang, L.-M.; Uttamchandani, D. Optical chemical sensing employing surface plasmon resonance. Electron Lett. 24, 23, 1988, 1469-1470.
[12] Homola J, Yee S S, Gauglitz G, Surface plasmon resonance sensors: review Sensors and Actuators B—Chemical, 54 (1-2): 3-15, 1999
[13] Homola J, Present and future of surface plasmon resonance biosensors, Anal. Bioanal. Chemistry, 377 (3): 528-539 2003
[14] Alexander, C., Andersson, H. S., Andersson, L. I. et al., Molecular imprinting science and technology: a survey of the literature for the years up to and including 2003. J. Mol. Recognit., 2006, 19 (2): 106-180.
[15] Mayes, A. G., Whitcombe, M. J., Synthetic strategies for the generation of molecularly imprinted organic polymers. Adv. Drug Del. Rev., 2005, 57 (12): 1742-1778.
[16] Chianella, I., Lotierzo, M., Piletsky, S. A., et al., Rational design of a polymer specific for microcystin-LR using a computational approach. Anal. Chem., 2002, 74 (6): 1288-1293.
[17] Karim, K., Breton, F., Rouillon, R., et al., How to find effective functional monomers for effective molecularly imprinted polymers? Adv. Drug Del. Rev., 2005, 57 (12): 1795-1808.

2. Background of the Invention

Surface plasmon resonance (SPR) is a physical process that occurs when plane-polarized light irradiates a metal film under conditions of total internal reflection (TIR). A detailed description of this process is given in reference 4. The surface plasmon evanescent wave (SPEW) is created at the interface between e.g. a glass prism and a metal (gold or silver) layer, irradiated by light under the conditions of TIR. Under TIR the incident photons are absorbed and converted into surface plasmons (particle name of the electron density waves). In the absence of metal the reflected photons create an electric field (evanescent wave, or, shortly, EW) on the opposite side of the glass prism surface. In metal films, placed on mentioned side of prism, surface plasmon enhances EW by several orders and generates SPEW (FIG. 1). SPEW extends into the medium on either side of the metal film and decays exponentially. The power of SPEW depends on angle of incidence θ (see, for example References 11 and 12).

U.S. Pat. No. 6,379,976 discloses an analytical method for monitoring polymerization or coagulation in a fluid using SPR. Polymerization is carried out in a solution in contact with the gold sensor surface, however the incident light is only used to follow the polymerization process, which is thermally-activated. Control over the position or the thickness of the polymer film arising from the SPR condition was not claimed.

A lithographic process has been reported to use the plasmon field in the vicinity of silver nanoparticles to expose a solid layer of positive-working photoresist using a glancing beam of incident visible light [3-5]. US20030129545 discloses such a system, however no polymerization process was initiated (the resist used is rendered soluble by exposure by a photochemically-activated change in pendant groups on the resist polymer) and the nanoparticles were directly irradiated with light, not through a prism. The particle-based system was capable of replicating mask features at dimensions smaller than the wavelength of the light used. This property of the plasmon field is not relevant to the present invention.

US20050233262 also discloses a near-field application for lithographic patterning of a resist surface using a metal mask, where the plasmon field is generated at the edges of the metal features of the mask. In this case the exciting light is shone through the mask and a solid resist surface is again patterned at a length-scale smaller than the wavelength of the incident light.

Reference [6] also describes the patterning of photoresist layers, in this case by surface plasmon enhanced two-photon polymerization in the vicinity of “bowtie optical nanoantennae”.

In the above examples, photochemical changes in resist layers have been attributed to the surface plasmon energy. It has been shown, however, that the surface of evaporated gold films always exhibits some roughness, which is evident as a source of photons by scattering [7,8]. The scattering of light from the surface of the metal, caused by surface plasmons, has been widely used to study molecular layers by Raman or IR spectroscopy and for molecular investigations using fluorescence labels [9,10].

Similar properties of the EW have been used in holographic recording [1-2]. Here the polymerization has been performed on the surface of glass which is not coated by metal. The reason that few attempts to use evanescent energy for polymerization at metal interface have been published lies in the non-radiative nature of SPR phenomena.

SPR sensors are a valuable tool for characterizing and quantifying biomolecular interactions (for examples, see References 11-13). A typical SPR biosensor set-up consists of a thin layer of metal in optical contact with an ATR (attenuated total reflection) prism. Incident light under TIR conditions produces a SPEW at the outer boundary of the metal. Biomolecular interactions occurring at the sensor surface change the refractive characteristics of the analyte, with which the outer metal surface is in contact. Measurement of the intensity and angle of the reflected light wave therefore provides information about interactions in the substrate.

Devices using SPR sensors are mainly used for detecting binding to materials (such as proteins, antibodies, enzymes etc) bound to the metal layer. The metal surface (usually gold) is modified covalently using existing chemistry to immobilize the sensing molecules.

### BRIEF DESCRIPTION OF THE DRAWINGS

FIG. 1 depicts the formation of polymer on the gold surface irradiated by laser light using an attenuated total reflection (ATR) prism at the conditions of TIR.

FIG. 2(a) depicts the AFM images of gold treated and non-treated with “piranha” solution; Left—the AFM image of gold before regeneration. The average roughness of the surface is 1.2-1.4 nm. Right—the AFM image of the gold surface after 10 min in ‘piranha’ mix. The roughness has decreased up to 0.3 nm.

FIG. 2(b) depicts light scattering laser spots, observed at the SPR angle position. Right—10 min treated in “piranha” mix surface of gold film, left—untreated surface at the same gold chip.

FIG. 3 depicts kinetic dependence of SPR angle shift (proportional to amount of polymer at surface of Au) for Au surface, treated with piranha solution (10 min) and without any chemical treatment. A—addition of monomer solution to SPR cell, B—addition of solution containing monomer and initiator to SPR cell.

FIG. 4 depicts the effect of the time of polymerization, showing the dependence of reflectance on the angle of incidence B of laser light (SPR curves). 1—bare surface of gold film. 2—after filling of cell with monomer. 3—after 1 min polymerization. 4—after 2 min polymerization.

FIG. 5 depicts the kinetic dependence of the SPR angle position on the concentration of the sulfinate salt (here referred to as initiator). Shift of SPR angle position reflects the amount of polymer at Au surface.

FIG. 6 Shows the effect of reducing the dye concentration (one part of the photoinitiator couple) on the extent of polymerization. The monomer concentration was 5% 1:9 N,N-methylene-bis-acrylamide:acrylamide in water. 100% standard dye concentration corresponded to the addition of 10 μl/ml of the dye concentrate (10 mg/ml). The SPR curves shown are recorded in pure water in contact with the gold and/or polymer layers.

FIG. 7 depicts the optical microscope image of the surface of a polymer layer.

FIG. 8 shows the dependence of the reflectance value (expressed in arbitrary units) at the SPR condition for methacrylic acid-based polymer layers in water, prepared using a range of methylene blue dye concentrations. The monomer mixture comprised methylene-bis-acrylamide:methacrylic acid, 9:1 as a 2.5% solution in water.

### DESCRIPTION OF THE INVENTION

The present inventors have found that the energy of the SPEW and scattered light is sufficient to activate a photoinitiator system and generate free radicals. In general, the present invention describes the initiation of photochemical reactions at a metal-solution interface irradiated by light. Surface plasmon energy is used to initiate reaction of species in solution, the reaction occurring at, on or near a surface which is in contact with the solution.

The present invention describes an application of this effect e.g. for polymerization purposes.

The energy of the SPEW can cause initiation of a photochemical reaction in a reaction mixture. For example the energy of the SPEW can cause a polymerization process in a monomer mixture, when the power of the light source is strong enough to decompose initiator molecules or stimulate a dye-sensitized process and generate radicals. Since the amplitude of waves in the SPEW field decays exponentially, the photochemical reaction does not proceed far from the surface where the SPEW is generated (typically <1000 nm). In the case of polymerization, this means that the polymerization does not proceed far from the surface where the SPEW is generated (typically <1000 nm). A polymer film may therefore formed with a depth of <1000 nm).

In one aspect, the invention therefore provides a method of producing a chemical reaction in a photo-activatable reaction mixture, comprising producing a surface plasmon evanescent wave (SPEW) at a reaction site on the surface of a film of a plasmon-active material which is in contact with the photo-activatable reaction mixture, to initiate the reaction in a reaction region, adjacent to the reaction site, wherein the SPEW is produced by irradiating from the opposite side of the film, through a translucent medium.

Means for producing surface plasmon waves in conducting films are well known in the art. These include prisms, optical waveguides, diffraction gratings and metal nanoparticles. Many such methods are described herein and in the references cited above. The terms SPW (surface plasmon wave) and SPEW (surface plasmon evanescent wave) may be used interchangeably.

By ‘translucent medium’ is meant a medium through which light is able to pass, in order to irradiate the side of the film opposite the reaction site. The medium need not be fully transparent, as long as enough light is able to pass through the medium to produce an evanescent wave at the interface with the plasmon-active film. In most preferred embodiments, however, the medium is fully transparent and allows all of the incident light to pass through it. Preferred materials for the translucent medium are solid materials, particularly optical quality glass or plastics.

Preferably the translucent medium is in the form of a prism, more preferably an ATR prism as known in the art. In some alternative embodiments it may be in the form of an optical waveguide. Preferably the prism is made of glass or plastic. Preferably the irradiation of the film through a translucent medium is under conditions of total internal reflection (TIR) which produces an evanescent wave at the interface with the film, which is enhanced by surface plasmons in the conducting film to produce a surface plasmon wave (SPW) also called a surface plasmon evanescent wave (SPEW), which penetrates though the film to the opposite surface, which is in contact with the reaction mixture.

In some preferred embodiments the translucent material comprises a prism, waveguide or similar structure and a removable layer of the same translucent material, such as a slide, in optical contact with the prism or waveguide. In these embodiments the film of conducting material may be held on the slide. Preferably the removable layer is in optical contact with the prism or waveguide by virtue of a layer of index matching liquid.

As was stated above, the prism may be part of an SPR instrument layout. The refractive index of the prism, and its geometry and material can vary, for example between instrument manufacturers. In some cases the prism may be made of a plastic material. The prism is preferred, but is not necessary, since the evanescent field can be generated and used in other formats as well e.g. gold-coated glass slides with waveguides etc.

The nature of the irradiation used in the method of the invention may depend on the refractive index of the translucent medium. The wavelength of the light, and the angle of irradiation to produce evanescent waves at the interface with the film can be chosen accordingly, using known techniques in the art. The required wavelength if the light will also depend on the nature of the photo-activatable reaction mixture, for example because different photo-initiator molecules will be activated at different wavelengths. Preferably a laser light source is used in the method. Irradiation occurs through the translucent medium, to the side of the film opposite the surface which is in contact with the solution, which can be referred to as the underside of the film (although it will be understood that the orientation of the film may vary, the ‘underside’, as used herein, always refers to the side of the film opposite the side which is in contact with the reaction mixture). This means that the radiation does not need to pass through the reaction mixture. Therefore initiation of the reaction in the bulk solution does not occur.

The film can be made of any plasmon-active material, i.e. any material capable of producing surface plasmons. In some preferred embodiments the film is composed of a conducting material, preferably a metal. A gold film is particularly preferred, however silver, aluminium, chromium, other metals and semi-conductors, known to those skilled in the art, can also be used. In some embodiments more than one such material may be present in the film.

The film of plasmon-active material must be sufficiently thin that the generated SPEW can extend through it to the reaction mixture on the opposite side of the film. Preferably the film is less than 1000 nm thick, more preferably between 10 and 1000 nm thick, more preferably less than 500 nm, and in some embodiments may preferably be less than 300, 200, 100, or 50 nm thick

On the opposite side to the translucent medium, the film is in contact with a photo-activatable reaction mixture. Preferably only one side of the film is in contact with the reaction mixture. When the SPW is generated in the film it extends into the reaction mixture from a reaction site on the film surface, and initiates a chemical reaction in a reaction region adjacent to the reaction site. In preferred embodiments the reaction site is opposite the point where radiation occurs on the underside of the film. The reaction region is a region in the reaction mixture, adjacent to the reaction site on the film surface, in which the photochemical reaction is initiated. In some preferred embodiments the reaction site is a localised area or region on the surface of the film. The SPEW does not penetrate far into the reaction mixture, and so the reaction region, in which the chemical reaction is initiated, is localised in the vicinity of the film. The reaction region is on, at or very near the surface of the film. Preferably the reaction is localised within 1000 nm of the surface of the film, more preferably within 500 nm. In some embodiments it may preferably extend less than 400 nm, 300 nm, 200 nm, 100 nm, or 50 nm from the surface. Most preferably the reaction region is localised on the surface of the film and the chemical reaction results in deposition of products on the film, for example in the creation of a polymer layer over the reaction site.

By photo-activatable reaction mixture is meant a reaction mixture comprising the reagents for a reaction which is activated by electromagnetic waves, in particular by light. In the method of the invention the reaction is activated by the surface plasmon wave. The photo-activatable reaction may be a photo-initiated reaction in which initiator molecules are decomposed by the SPW and generate radicals which then react further. Preferably the reaction mixture is a solution phase reaction mixture. The reaction preferably produces reaction products which are deposited on the surface of the film. In alternative embodiments the reaction may involve reacting immobilised species, which are immobilised on the film surface, with species in the bulk reaction mixture. In these embodiments the SPW may activate either the bound species or the species present in the solution, in the reaction region.

The photo-activatable reaction may therefore be any reaction which is capable of being initiated by the energy of a SPW. In especially preferred embodiments, the photo-activatable reaction mixture is a polymerisation reaction mixture. The reaction products in these embodiments are polymer films which are deposited on the surface of the film. The thickness of the polymer film is controlled, because the initiation of the reaction occurs only in the reaction region close to the film. The growth of the polymer film can also be monitored, preferably using SPR in situ, and stopped at the desired thickness. Preferably the polymer films formed in the method are less than 1000 nm, more preferably less than 500 nm thick. In some preferred embodiments the polymer films generated may be less than 300 nm, 200 nm, 100 nm, 50 nm or 20 nm thick. Various polymeric systems may be used in combination with the proposed activation mechanisms. Usually the polymerization is performed in the presence of solvent which helps to solubilize components and to create pores in the polymer matrix, suitable for an effective transport of solution, required for application of these materials. The polymerization mixture normally contains initiator which generates free radicals in radical polymerization. The monomers and cross-linkers used for polymer preparation are usually selected from the group consisting of: acrylic acid, its esters, amides and derivatives thereof; methacrylic acid, its esters, amides and derivatives thereof; vinyl esters, vinyl aromatics, allyl compounds, styrene or their derivatives and mixtures thereof, non-exclusive examples include N,N-methylene-bis-acrylamide, acrylamide, ethyleneglycol dimethacrylate, divinylbenzene, methacrylic acid, 2-hydroxyethyl methacrylate, itaconic acid, 2-acrylamido-2-methyl-propane-1-sulfonic acid and their mixtures. The monomers are generally present in the polymerization mixture in an amount of from about 1 to 80 vol. %. The solvent is selected from a group including aliphatic hydrocarbons, aromatic hydrocarbons, esters, alcohols, ketones, ethers, butyl alcohols, isobutyl alcohol, dimethyl sulfoxide, formamide, cyclohexanol, H₂O, glycerol, sodium acetate, aqueous buffer solutions, solutions of soluble polymers, and mixtures thereof. These solvents may also be suitable for other photo-activated reactions, in other embodiments.

Conventional free-radical generating photoinitiators may be employed to initiate polymerization or other photochemical reactions. Examples of suitable initiators include peroxides and their derivatives such as OO-t-amyl-O-(2ethylhexyl)monoperoxycarbonate, dipropylperoxydicarbonate, and benzoyl peroxide, as well as azo compounds such as azobisisobutyronitrile, 2,2′-azobis(2-amidinopropane)dihydrochloride, 2,2′-azobis(isobutyramide)dihydrate and 1,1′-azobis (cyclohexane carbonitrile). Alternatively two, three or more component photoinitiators may be used. The initiator may consist of a one or two component photo-redox couple. for example mixtures of methylene blue and sodium p-toluenesulfinate, with or without added accelerator. This is given as a non-exclusive example and other photo-redox couples suitable for use as initiators in the present invention are known in the art. The initiator is generally present in an amount of about 0.01% to 5% by weight of the reacting species. In a polymerisation mixture, the initiator may preferably be present in an amount of from about 0.01 to 5% by weight of the monomers. In other embodiments the initiator could be a triplet sensitiser, including sensitising dyes.

In other embodiments, the invention provides a method for cross-linking of oligomers in solution. The term oligomers is known in the art and refers to a molecule formed from a few monomer units. Preferably the oligomers for use in the present invention have molecular weight >500 Daltons and each molecule should on average possess more than one (preferably two or more) functional groups (e.g. double bonds) capable of undergoing a cross-linking reaction. Cross-linking can be initiated using photo-initiators such as those discussed above.

In still further embodiments, the invention provides a method wherein the polymerisation is performed in the presence of a template species, to form a molecularly imprinted polymer layer. Molecularly imprinted polymers (MIPs) are known in the art (see References 14-17) and are produced by polymerisation in the presence of a molecular template. In these embodiments, polymerisation may be initiated by the interaction of SPEW in the proximity of a solution of monomers, using a photo-initiator, as described in a previous embodiment, with the addition of a template species to the monomer mixture.

Various methods of preparation of MIPs are known to those skilled in the art and many are described in the references [14, 15] and the sources cited therein.

Template species are generally molecular or macromolecular in nature, such as biomolecules or drug molecules, although the imprinting of other species, including, but not limited to: metal ion, anions, cations, supramolecular complexes, polymers, peptides, proteins, virus particles, spores, yeast cells, bacterial cells, mammalian cells, organic and inorganic crystals have been disclosed. Some examples of possible templates therefore include biological receptors, nucleic acids, hormones, heparin, antibiotics, vitamins, drugs, cell components and components of viruses such as carbohydrates, saccharides, nucleoproteins, mucoproteins, lipoproteins, peptides and proteins, glycoproteins, glucosaminoglycanes and steroids. The interactions between the template and elements of the polymer can include covalent, non-covalent, semi-covalent and metal-ion mediated interactions or any others know to those skilled in the art, or any combination thereof. In particular non-covalent interactions can include, but not be limited by, van der Waals forces, dipole-dipole interactions, electrostatic interactions, hydrogen-bonding, steric effects and hydrophobic interactions and another other phenomena for which a favourable enthalpy and/or entropy of binding is in operation. The template is typically present in a quantity from 0.01% to 20% with respect to the monomer mixture, preferably from 0.5% to 10% with respect to the monomer mixture.

The monomer mixture for producing molecularly imprinted polymers by the methods of the invention may contain one or more components, each bearing two or more polymerisable functional groups, e.g. vinyl groups, including vinyl aromatics, N-vinyl heterocylic residues, vinyl esters and vinyl ketones, esters and amides of acrylic acid and its derivatives and esters and amides of methacrylic acid and its derivatives, such that these components are capable of acting as cross-linkers. The cross-linkers may constitute from 10% to 95% of the monomer mixture. Typical cross-linkers are well know to those skilled in the art and include, but are not limited to the following examples: methylene-bis-acrylamide, ethylene-bis-acrylamide, 1,4-bis-acryloylpiperazine, divinylbenzene, ethyleneglycol dimethacrylate, trimethylolpropane trimethacrylate, pentaerythritol triacrylate, pentaerythritol tetraacrylate, pentaerythritol trimethacrylate or pentaerythritol tetramethacrylate and mixtures thereof. The remaining components of the monomer mixture which are not included solely for their ability to act as cross-linkers, may include additional monomer or monomers which is/are not expected to play a major role in the creation of imprints, but is/are present to modify the degree of cross-linking in the final polymer, or to modify its interactions with solvent, or other such role or combination of roles which will be favourable to the sensing application for which the MIP is to be created. More important however, is the presence of monomer components selected from those which are predicted to engage in interactions with the template species, that lead to the formation of “imprints”, as described above. The monomers included for their ability to engage in interactions with the template species may be selected intuitively, based on the knowledge and experience of the skilled practitioner in the art, or on the basis of combinatorial screening, or using a computer-aided experimental design and chemometric approach to selecting suitable monomers or combinations thereof, or other methods known to those skilled in the art.

Preferably the monomer selection for these embodiments can be made on the basis of a virtual screening approach, as disclosed in WO/01/55235, further examples being given in references [16, 17].

Use of SPR phenomena to initiate photo-chemical reactions of molecules in solution has not previously been contemplated. It is not obvious that there is sufficient energy in the light beam used to generate the SPEW to initiate polymerisation, since only low power lasers are used in SPR sensing instruments and instruments of this type are designed to monitor reactions and not to initiate them. The present invention is therefore counter-intuitive to the normal mode of operation of the instrument. In addition, the non-radiative nature of the evanescent wave is a factor as mentioned above.

### DETAILED DESCRIPTION

In certain preferred embodiments, the present invention describes creation of thin polymeric films at metal-solution interface irradiated by light. It is possible to achieve polymerization onto the metal surface if light is applied from the opposite to solution side, that is to say, the light is applied to the side of the film opposite to that in contact with the solution. Specifically, polymerization is powered by the electromagnetic field of light-generated surface plasmon which transmits through the metal film and enhances EW. The energy of surface plasmon evanescent field (either directly or through the photons generated by surface roughness or a combination of both) is used to activate to the formation of radicals which leads to polymerization or cross-linking. Due to the nature of surface plasmon evanescent field the polymerization takes place in close proximity to the metal layer. The benefits offered by the proposed approach are fourfold: (i) the polymerization is localized and takes place in close proximity to the metal layer and does not penetrate deep into solution; (ii) the polymerization can be switched on and off by applying light; (iii) the possibility exists for using the SPR set-up for both, generation of polymer layer and for monitoring/controlling the polymerization process; (iv) the possibility exists for using the same or similar experimental SPR set-up for monitoring of interactions between created polymer layers or entrapped/immobilized molecules within the layers with analytes.

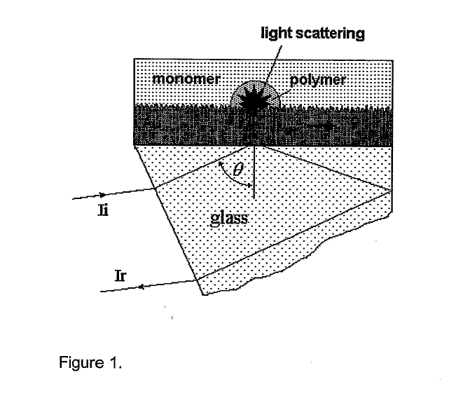

SPR sensor instruments with a geometry such as that described above (and depicted in FIG. 1) can be used to demonstrate the present invention. This is the NanoSPR® device (http://www.nanospr.com/), but its layout is similar to other SPR instruments (e.g. Biacore®) which are mainly used as (bio)sensing devices, detecting binding to materials (proteins, antibodies, enzymes etc.) bound to the metal layer. The detection mechanism relies on changes in the local refractive index in the vicinity of the surface of the metal. This is generally gold, since there are many existing chemistries to covalently modify the surface of gold.

In the case of the NanoSPR®, the prism set up is as in FIG. 1, such that the path of the reflected light is directed back parallel to the incident light, as the photodiode detector is mounted below the laser light source. In other instruments, the reflected light may be sent to the opposite side of the prism to the incident beam. In those cases a triangular or hemi-cylindrical prism can be used, rather than the trapezoid prism with one mirrored face used in the NanoSPR® machine.

There is also the possibility of using a metal film deposited on a transparent (e.g. glass) slide, in optical contact with a prism, via a matching liquid. The index matching liquid prevents losses of the light by additional reflectances at the prism-glass slide interface. The use of gold coated glass slides allows the metal surface to be renewed between sensor (or polymerisation) runs. If the gold were directly coated on the prism, it would be necessary to replace the prism for each run, hence it is advantageous to use gold-coated glass slides and index matching fluid. The gold-coated slide is a “disposable” for the biosensor. It can however be used repetitively over a long time.

One of the advantages of the present invention is that it is possible to grow a polymer layer at a point on the surface of a sensor chip/slide that is precisely the same position where (for example) antibodies or other sensing molecules need to be immobilised, for use in detection as described above. This can avoid having to derivatise the whole surface of the chip, consequently sensitivity may be improved and it may be possible to use less material (e.g. antibodies) than in the conventional set-up. Another advantage of polymerising directly on a sensor chip is that the process of polymerisation can be monitored at the same time as the polymer layer is being grown.

A first application of the present invention is the creation of thin polymeric films at a metal-solution interface irradiated by light. In one descriptive example a metal film is deposited either directly onto a glass prism with high refractive index or onto a glass plate being in optical contact with the prism via a matching liquid. In the TIR conditions some fraction of light (an evanescent wave) still penetrates to the outer glass surface and excites a surface plasmon in metal if the film is sufficiently thin, so that the energy flow reaches the metal-ambience interface (i.e. where the metal is in contact with the reaction mixture). SPEW energy and/or photons generated by surface plasmons on centres of surface roughness is utilized for decomposition of initiator molecules and generation of free radicals which are responsible for polymerization of monomers, activation of ligands or cross-linking of chemical monomeric and polymeric molecules. It would be difficult to discriminate the role of SPEW energy and generated photons in polymerization since in most practical cases they are presented together and most likely play complementary role. In all these cases however this is an SPR phenomenon which is overall responsible for the existence of both effects. One benefit of using SPR created in metal is significant amplification of energy in the local proximity to the metal surface (>10-20 times) as compared with energy of EW field achieved in the absence of metal. Another benefit of polymerization performed in this format is localization of polymerization zone which does not extend deep into solution.

These examples relate to the creation of layers with sensing capability, the polymeric film being one of the ways of providing a point of attachment for a binding (or recognition) element of an SPR biosensor. The present invention covers also polymerization in other systems such as diffraction gratings, waveguides, metal nanoparticles etc, where SPR phenomenon can be produced.

Another aspect of the present invention is the application of the proposed approach for reactions other than polymerization such as cross-linking and photochemical coupling. Indeed the energy generated by SPR can be harvested as described earlier for activating e.g. cross-linking of oligomeric solution which also would lead to formation of polymer on the metal surface. Alternatively photoreactive groups can be activated and forced to react with chemical and biological species for immobilization purposes. The examples of such reactions are well-known for specialists working with e.g. selective modification of functional groups in biological molecules such as proteins and nucleic acids.

Cross-linking of an oligomeric solution is analogous to the polymerisation process, except that higher molecular weight species will be captured by the chemistry. The resulting cross-linked material will be deposited on the surface. The oligomeric species preferably has a molecular weight >500 Daltons and each molecule should on average possess more than one (preferably two or more) functional groups (e.g. double bonds) capable of undergoing a cross-linking reaction.

A further aspect of the invention is the formation of molecularly imprinted polymer layers at the surface of the metal film. Molecularly imprinted polymers (MIPs) are formed by polymerisation of a monomer mixture in the presence of a template species, the monomer mixture containing monomers chosen for their ability to interact with the template. Following polymerisation a proportion of the residues corresponding to those which were engaged in interactions with the template in the pre-polymerisation state will become fixed in these interactions, creating sites which are complementary to the template, both in spatial and chemical aspects, once the template species has been removed by washing or chemical treatment. The vacant template sites thus formed (the “imprints”) retain a “memory” for the template and act as affinity sites, capable of selective and specific rebinding of the template.

Applications of MIPs include separation, chromatography, solid phase extraction and catalysis, however it is their ability to substitute for antibodies or other molecular recognition elements in chemical sensors, particularly in optical sensors, specifically those in which the method of sensing involves surface plasmon resonance (SPR), that are most important in the context of this invention.

Monomer selection for this aspect of the invention can be made on the basis of a virtual screening approach, as disclosed in WO/01/55235, further examples being given in references [16, 17]. In this approach monomer selection is based on the screening of a virtual library of monomers, comprising the energy-minimised molecular models of the library components, selected from monomers with a range of structure and functional features with potential to interact with a range of template features and functional groups, against a similarly energy-minimised model of the template structure. The output of the method is a table giving relative binding energies for the interactions between template and components of the library, ranked according to the binding score. Following the initial screening and selection of promising candidates for MIP synthesis, a molecular dynamics method can be employed to construct a model of the pre-polymerisation complex between the template and one or more of the selected monomer species in order to select suitable monomers or monomer mixtures and their relative proportions with respect to the template to be used in MIP synthesis.

MIP layers prepared according to the methods disclosed above can be freed of their template or of a large proportion of their template by washing with organic solvents and/or aqueous solutions and/or solutions of surfactant and/or those containing acidic or basic components selected for their ability to disrupt the interactions between the template and the polymer and to favour the removal of the template from the polymer without disrupting the structure of the polymer significantly or affecting its adhesion to the metal surface. Following template removal and equilibration of the polymer layers in the solvent, solvent mixture or buffer to be used in the sensor application, binding of the template or its analogues can be monitored by SPR using methods recommended by the instrument manufacturers or known to those skilled in the art. Generally binding events are detected due a change in local refractive index in the area interrogated by the SPEW. In the case of MIP layers bound at the metal surface the refractive index changes can be as a result of the presence of the bound analyte or the response of the polymer to binding of the analyte, such as for example expulsion of solvent, swelling or shrinkage of the polymer layer, or as a result of a combination of these effects resulting in a net change in the local refractive index.

In another embodiment of this aspect of the invention, pre-prepared MIPs in the form of soluble species or as species which can be dispersed as a colloid, such as those materials, the preparation of which is disclosed in U.S. Pat. No. 6,852,818 or WO/2006/129088, or by any other method known to those skilled in the art, can be immobilised at the surface of a non-imprinted, functional polymer layer, or other functional layer present at the surface of the metal, using any of the chemistries and methods described herein for the immobilisation of species possessing molecular recognition capabilities, to components bound to the metal surface by photo-activated processes initiated by interaction with the SPEW and its associated phenomena. In one such example this would involve capture of the particles, colloidal or soluble species bearing unreacted double bonds, by reaction with similar double bonds present on the layer attached to the metal surface thought the activation of photoinitiators capable of producing free radicals, as disclosed elsewhere in the invention.

Another aspect of the invention is about linking molecules or other species present in solution to functionalised surfaces. The functional surface could be a polymer, prepared by one of the methods described herein, or a polymer, protein, polysaccharide, a self-assembled monolayer (SAM) formed by deposition of thiols on the metal surface, or other such method known to those skilled in the art. The molecule or species to be coupled could be a small organic molecule, biotin, a protein, sugar, enzyme, lectin, polysaccharide, fragment of single or double-stranded DNA or RNA, an aptamer, cyclodextrin, calixarene, crown ether, antigen or monoclonal or polyclonal antibody, nanoparticle, including molecularly-imprinted polymer nanoparticles, or any other species known to those skilled in the art which are capable of specific interaction with another chemical species, such that the resulting coating can form the basis of an SPR (bio)sensor. The species to be coupled to the functionalised surface can be either unmodified or modified with one or more additional chemical functionalities (such as double bonds) to enable the immobilisation reaction to take place.

Another aspect of the present invention describes manipulation of binding, catalysis or reactive properties of the surface functional groups by SPR. Thus the binding between immobilized molecules, bound to the surface of the gold, such as spiropyrans, and analytes in solution would be affected by SPEW and/or photons due to change in ligand conformation. Many other examples of activation of chemical processes in electrical field or by irradiation (compatible with SPR format) are known to skilled artisan with knowledge of organic photochemistry.

A further aspect of the present invention describes use of an SPR detection protocol for monitoring of the polymerization reaction. The characteristic which makes SPR an analytical tool is that change in the environment within the range of the plasmon field (typically <1000 nm) causes a change in the angle of incidence θ or wavelength of light that resonates with the plasmon. That is, a chemical or physical change results in a change the angle of incidence θ or shift in the wavelength of light which is absorbed rather than reflected and the values of the θ or wavelength shift is quantitatively related to the magnitude of the chemical or physical change in the environment. Practically important is that during the polymerization the refractive index of created polymer is very different from the refractive index of monomer mixture. Thus formation of polymer can be easily monitored by observing e.g. shift in SPR resonance curve.

The present invention also describes application of SPR for the detection of interactions between created polymers or molecules immobilized or entrapped into the polymer with variety of analytes. The SPR monitoring of these interactions would be very convenient due to fact that created films are deposited by SPR process itself and as a result the thickness and location of polymers is ideally suited for SPR format. This would be particularly useful for sensor and assay applications.

The examples described above relate to the creation of layers with sensing capability, a polymeric film being one of the ways of providing the point of attachment for a binding (or recognition) element. Further embodiments of the present invention describe other applications of created structures in separation, holography and microelectronics. In all cases the advantages are taken from the controlled and localized nature of deposited films.

### EXAMPLES

The Examples are intended to illustrate, but not limit the scope of the invention.

### Example 1

### Preparation of Polymers

The polymer has been prepared using a NanoSPR® set-up (instrument model number NanoSPR-321), with ATR prism, as described above and in FIG. 1, at the TIR conditions. The glass prism with a refractive index of 1.6160 was selected as optimum for use with SPR in water, with a nominal ATR angle of 65 degrees. The gold coated slide (20×20×1 mm), coated with a 45 nm layer of gold over a 5 nm layer of chromium (NanoSPR devices, USA) was mounted on the upper face of the prism with the gold layer uppermost. A thin layer of index matching fluid (NanoSPR devices, USA) was applied between the two glass faces of the slide and the prism. Care was taken such that no air bubbles were trapped at the interface and excess index matching fluid was cleaned from the optical face of the prism. A transparent block with microfluidic connections, separated by a silicone elastomer spacer (approx 1 mm in thickness) was clamped to the gold-coated face of the slide. The silicone elastomer spacer had two cut-out areas which, when assembled with the transparent block, defined two chambers, each with its own microfluidic connections. Each of these chambers is capable of acting as separate channels, interrogated with a separate light beam, in the instrument. The fluidic connections were attached to a peristaltic pump (Gilson, France), such that liquids could be drawn into the sample chambers. The manipulations described below can be performed in either of the two sample chambers or both simultaneously. The NanoSPR® instrument was connected to a PC, via a USB interface and controlled by the NanoSPR® application software (NanoSPR devices, USA).

A solution of monomers was prepared comprising acrylamide (0.9 g) and N,N-methylene-bis-acrylamide (0.1 g) in water (10 ml). To this solution was added 100 μl of a solution of methylene blue in water (concentration 10 mg/ml of dye). Two 2 ml portions of the dye-containing monomer solution were placed into two screw-cap vials. To one of the vials was added 20 μl of a freshly prepared solution of sodium p-toluenesulfinate hydrate in water (10 mg/ml). The solution containing the sulfinate salt was stored in the dark by wrapping the outside of the sample vial with aluminium foil. Both solutions were degassed by passage of a stream of argon or nitrogen gas for at least 3 minutes.

The solution cell at the gold surface was filled with pure water (previously degassed by sonication), a device calibration was performed, using the calibrate function of the NanoSPR® software and the SPR curve in water was recorded at the outset of the experiment by scanning the angle of incidence of the incident light beam (Ii in FIG. 1). This is achieved in the NanoSPR® device by rotating the prism and solution cell assembly relative to the light source and detector, under software control. The light source was a diode laser emitting red light (GeAs laser, λ=670 nm). The contents of the solution cell were then replaced by a portion of the solution containing monomers and dye only and the SPR curve again obtained by scanning the angle of the incident light. The angle of the light beam was then adjusted to the position of TIR, indicated by the minimum point of the SPR curve. This was achieved using the “measurement in slope” function of the NanoSPR® control software. The light beam was temporarily blocked by an opaque obstruction while the contents of the solution cell were exchanged for a portion of the solution containing monomer, dye and sulfinate salt, the dye and sulfinate constituting a photoinitiator couple capable of initiating polymerization in red light. Removal of the blockage in the light beam allowed the SPR condition to be reestablished at the gold surface and polymerization to yield a spot of polymer at the gold surface rapidly ensued. The SPR apparatus was shielded from stray sources of light during the polymerization process. The deposition of polymer could be followed by the change in intensity of the reflected beam (Ir in FIG. 1) with time. The polymerization was limited by the penetration of the SPR field and did not occur indefinitely, but stopped after a short time, however polymerization could be stopped earlier if necessary by once again blocking the path of light beam before flushing the monomer sultan form the sample cell. No polymerization in solution was observed. The unreacted monomer solution was removed from the solution cell and the polymer washed with further fresh water until the SPR curve showed no further changes on subsequent washes. The SPR curve was then recorded to show the presence of the polymer spot on the gold surface. Layer thicknesses can be calculated from the refractive index of the polymer layers formed. Layers of thickness between 20 and 200 nm have been observed under carefully controlled conditions, however thicker layers, up to 1000 nm may also be formed, depending on concentration and nature of the monomer mixture and the concentration of the initiator components.

### Example 2

### Influence of Surface Roughness

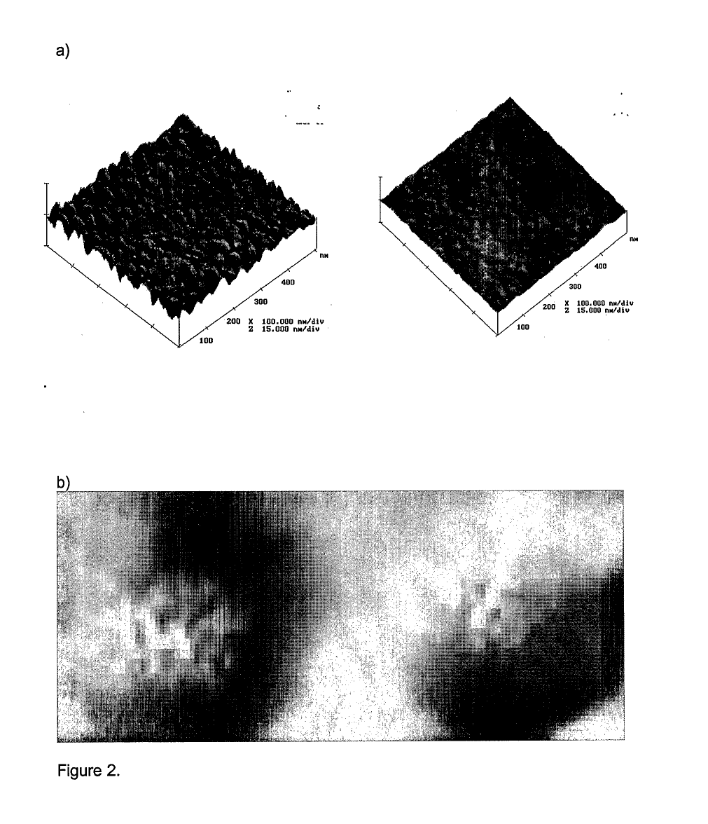

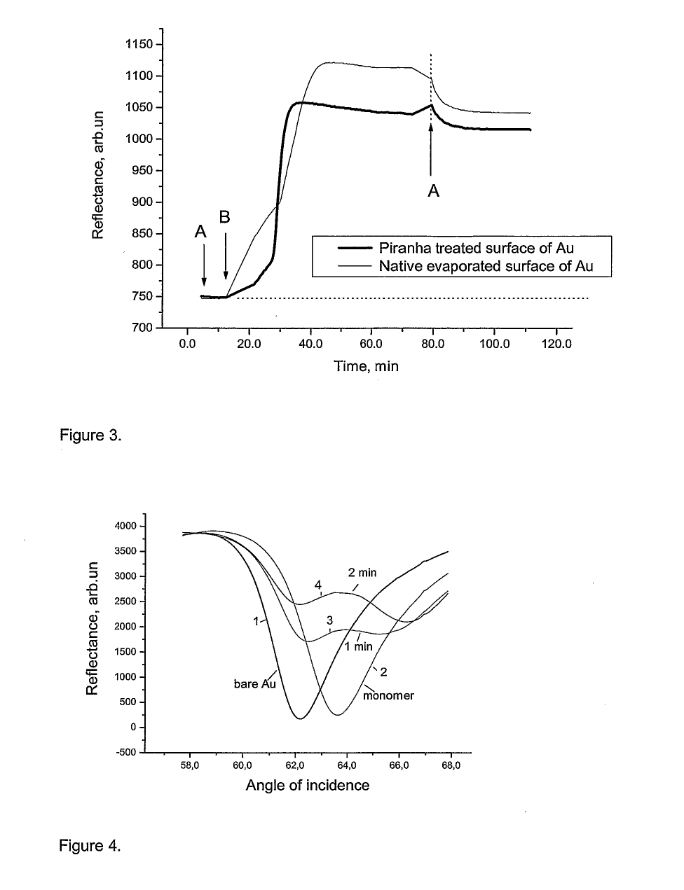

One half of the gold surface was treated with freshly prepared “piranha solution” (H₂SO₄/H₂O₂=3/1) for 10 min to minimize roughness. The light scattering from the treated area became less pronounced as compared with untreated region (see FIG. 2). As a result of this treatment not only the scattering of light decreased, but the efficiency of polymer formation was also slightly reduced (FIG. 3).

### Example 3

### Influence of Polymerization Parameters Time of Polymerization and Concentration of Initiator

### (FIGS. 4,5)

The System Described in Example 1 can be Manipulated to Produce More or Less polymer by adjustment of the concentration of each of the elements of the polymerization system: thus limiting the time of irradiation, adjusting the concentration of the monomer mixture, adjusting the methylene blue (dye) concentration or the concentration of the sulfinate salt, or a combination of these factors, can all be used to manipulate the amount (thickness) of polymer formed. In addition other factors such as ionic strength, pH, temperature, monomer composition and the presence of organic solvents will have an influence on the polymerization.

The effect of polymerization time upon the extent of polymer formation is shown in FIG. 4.

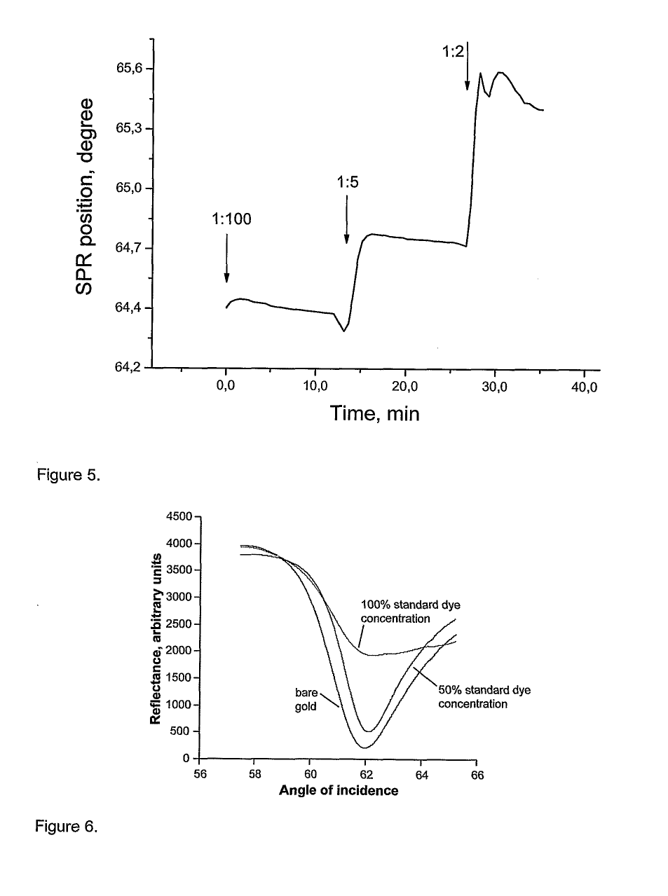

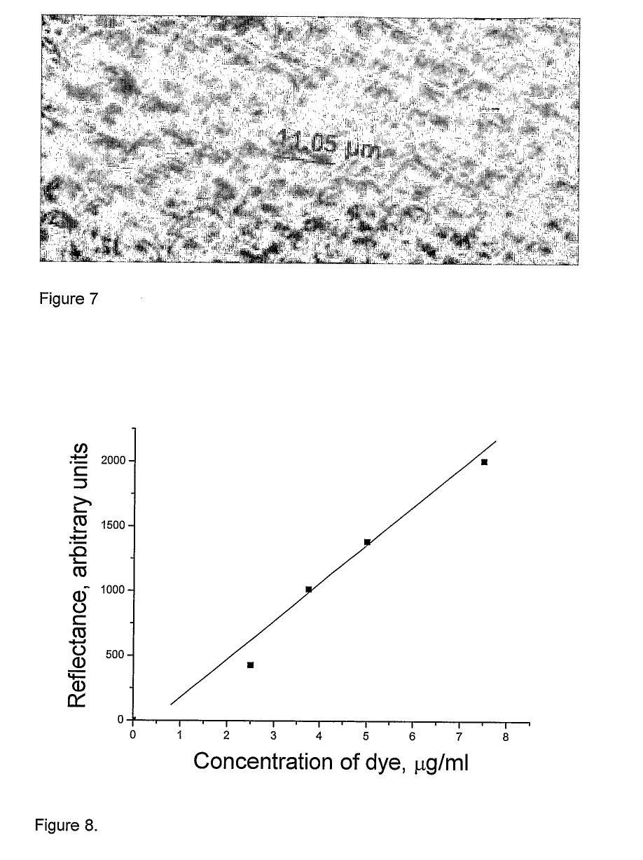

The effect of the sulfinate salt concentration was demonstrated by sequential addition of aliquots of the concentrate to a polymerizable mixture under conditions of SPR (FIG. 5).

The effect of dye concentration on the extent of polymerization is shown in FIG. 6. The examples given here demonstrate that a great deal of control over the thickness of the polymer film can be exerted by varying the polymerization conditions, not limited by the above examples.

### Example 4

### Formation of Methacrylic Acid-Based Polymers

The process described in Example 1 was repeated except that a monomer stock solution was prepared comprising 0.1 g of methylene-bis-acrylamide and 0.9 g of methacrylic acid dissolved in 10 mL of water. In order to prepare the solutions to be loaded into the SPR sample chamber, aliquots of this stock solution, (0.5 mL) were further diluted with water (1.5 mL) to prepared 2 samples of monomer solution. Methylene blue solution (5 μL of a 10 mg/mL solution in water) was added to each of the two samples. To one of the two solutions was added 20 μL of water, to the other was added 20 μL of a freshly prepared solution of sodium para-toluenesulfinate hydrate (10 mg/mL in water). The latter solution was labelled as the photosensitive solution and the container wrapped in foil to protect the contents from light. After degassing the two solutions, the polymerisation procedure described in Example 1 was followed. After preparing the NanoSPR instrument using a fresh gold-coated slide, the non-photosensitive solution was first loaded into the sample cell and the angle of the prism adjusted to that corresponding to the TIR condition, using the “measurement in slope” function of the NanoSPR® software. At this point the path of the laser light was obstructed with an opaque object and the photosensitive solution was admitted to the cell. Removal of the opaque object from the light path allowed the SPEW to be established at the surface of the gold and for polymerisation to proceed. Polymerisation was complete in less than 5 minutes, after which time the contents of the cell were flushed with pure water.

The procedure described above was repeated, except that the amount of dye solution added to each aliquot of the diluted stock solution was 7.5, 10 or 15 μL instead of the 5 μL in the above example. In each case the other conditions remained the same, including the quantity of water (in the case of the non-photosensitive sample) and freshly prepared sodium para-toluenesulfinate hydrate solution (in the case of the photosensitive sample) that was added. A fresh gold slide was used in each case. The dependence of the relative change in reflectance value (arbitrary units) due to the presence of the polymer layer, deposited on the gold, in a water-filled cell, on the methylene blue concentration can be seen in FIG. 8. It is clear that there is a direct relationship between the dye concentration and the quantity of polymer formed in the methacrylic acid-based polymers, similar to that observed for acrylamide-based polymers. Polymer film thicknesses were estimated as 20±5 nm when 5 μL of dye solution was used and 60±10 nm, 150±20 nm and 200±30 nm when 7.5 μL, 10 μL and 15 μL of dye solution was used respectively

1. A method of producing a chemical reaction in a photo-activatable reaction mixture, comprising producing a surface plasmon evanescent wave (SPEW) at a reaction site on the surface of a film of a plasmon-active material which is in contact with the photo-activatable reaction mixture, to initiate the reaction in a reaction region adjacent to the reaction site, wherein the SPEW is produced by irradiating from the opposite side of the film, through a translucent medium.

2. A method according to claim 1, wherein the irradiation is performed under conditions of total internal reflection (TIR) at the opposite side of the film to that in contact with the reaction mixture.

3. A method according to claim 1, wherein the translucent medium comprises a prism.

4. A method according to claim 1, wherein the translucent medium comprises a prism in optical contact with a removable layer of the same translucent material.

5. A method according to claim 1, wherein the plasmon-active material is a metal.

6. A method according to claim 5, wherein the metal is gold or silver.

7. A method according to claim 1, wherein the film of plasmon-active material has a thickness of less than 1000 nm.

8. A method according to claim 1, wherein the film of plasmon-active material has a thickness of less than 100 nm

9. A method according to claim 1, wherein the chemical reaction produces products which are deposited on the surface of the metal film.

10. A method according to claim 9, wherein the chemical reaction is a polymerisation reaction.

11. A method according to claim 9, wherein the reaction mixture comprises oligomeric species in solution and the chemical reaction comprises the cross-linking of the oligomers.

12. A method according to claim 1, wherein the reaction region extends less than 1000 nm into the reaction mixture from the film surface.

13. A method according to claim 1, wherein the chemical reaction comprises reaction of molecules immobilized on the film surface.

14. A method according to claim 1, further comprising the step of monitoring the progress of the chemical reaction using SPR measurement.

15. A method according to claim 10, wherein the reaction mixture comprises one or more monomers selected from: acrylic acid and esters, amides and derivatives thereof; methacrylic acid and esters, amides and derivatives thereof; vinyl esters, vinyl aromatics, allyl compounds, styrene and derivatives thereof.

16. A method according to claim 15, wherein the one or more monomers are selected from N,N-methylene-bis-acrylamide, acrylamide, methacrylamide, ethyleneglycol dimethacrylate, divinylbenzene, acrylic acid, methacrylic acid, 2-hydroxyethyl methacrylate, itaconic acid, 2-acrylamido-2-methyl-propane-1-sulfonic acid.

17. A method according to claim 15, wherein the monomer is present in the reaction mixture in an amount of between 1 and 80 vol. %.

18. A method according to claim 15, wherein the polymerisation is performed in the presence of a template species, to form a molecularly imprinted polymer layer.

19. A method according to claim 1, wherein the reaction mixture comprises a radical photo-initiator.

20. A method according claim 19, wherein the initiator consists of a one or two component photo-redox couple.

21. A method according to claim 20 wherein the photo-redox couple comprises methylene blue and sodium para-toluenesulfinate.

22. A method according to claim 19, wherein the initiator is a peroxide or an azo compound.

23. A method according to claim 22, wherein the initiator is selected from OO-t-amyl-O-(2-ethylhexyl)monoperoxycarbonate, dipropylperoxydicarbonate, benzoyl peroxide, azobisisobutyronitrile, 2,2′-azobis(2-amidinopropane)dihydrochloride, 2,2′-azobis(isobutyramide)dihydrate and 1,1′-azobis (cyclohexane carbonitrile).

24. A method according to claim 19, wherein the initiator is present in the reaction mixture in an amount of between 0.01 and 5% by weight.
